(19) United States
(12) Patent Application Publication
(10) Pub. No.: US 2021/0359986 A1
(43) Pub. Date: Nov. 18, 2021

(54) TERMINAL DEVICE, INFORMATION PROCESSING METHOD, AND NON-TRANSITORY COMPUTER READABLE STORAGE MEDIUM

(71) Applicant: Yahoo Japan Corporation, Tokyo (JP)

(72) Inventor: Hidehito GOMI, Tokyo (JP)

(21) Appl. No.: 17/197,869

(22) Filed: Mar. 10, 2021

(30) Foreign Application Priority Data
Mar. 17, 2020 (JP) 2020-046610

(51) Int. Cl. H04L 29/06; H04L 9/30; H04L 9/32

(52) U.S. Cl. CPC H04L 63/083; H04L 9/3247; H04L 9/30

(57) ABSTRACT

A terminal device according to the present application includes an authentication unit and a transmission unit. The authentication unit performs, in response to reception of a transmission request for authentication information for use in authentication of a user from an authentication device that performs the authentication of the user in a predetermined service, the authentication of the user, based on information of the user detected by a predetermined detection device. The transmission unit transmits, in a case where the authentication is performed by the authentication unit, the authentication information on the user to the authentication device.

### CROSS-REFERENCE TO RELATED APPLICATIONS

The present application claims priority to and incorporates by reference the entire contents of Japanese Patent Application No. 2020-046610 filed in Japan on Mar. 17, 2020.

### BACKGROUND OF THE INVENTION

### 1. Field of the Invention

The present disclosure relates to a terminal device, an information processing method, and a non-transitory computer readable storage medium having an information processing grogram stored thereon.

### 2. Description of the Related Art

In recent years, a technology of facilitating authentication of a user has been proposed. For example, the authentication technology called Fast Identity Online (FIDO (registered trademark)) has been proposed.

However, the technology described above has room for further facilitation of authentication.

In conventional FIDO authentication, a public key is registered in an authentication server and is used for user authentication on the authentication-server side. Thus, at the time of making FIDO authentication as an add-on to an existing password authentication system, in some cases, the existing password authentication system needs, for example, a function of registering a public key for user authentication added to the existing password authentication system. Such an alteration to an existing system results in a barrier to introduction of FIDO authentication, in some cases.

### SUMMARY OF THE INVENTION

It is an object of the present invention to at least partially solve the problems in the conventional technology.

According to one aspect of the subject matter described in this disclosure, a terminal device includes (i) an authentication unit configured to perform, in response to reception of a transmission request for authentication information for use in authentication of a user from an authentication device that performs the authentication of the user in a predetermined service, the authentication of the user, based on information on the user detected by a predetermined detection device, and (ii) a transmission unit configured to transmit, in a case where the authentication is performed by the authentication unit, the authentication information on the user to the authentication device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram of exemplary authentication processing in which remote authentication is performed with local authentication, according to an exemplary embodiment of the present disclosure;

FIG. 2 illustrates an exemplary configuration of an authentication system according to an embodiment;

FIG. 3 illustrates an exemplary configuration of a terminal device according to the embodiment;

FIG. 4 illustrates an exemplary authentication-information database according to the embodiment;

FIG. 5 illustrates an exemplary secret-key database according to the embodiment;

FIG. 6 is a flowchart of a processing procedure of remote authentication with local authentication, performed by the terminal device according to the embodiment; and

FIG. 7 illustrates an exemplary hardware configuration.

### DETAILED DESCRIPTION OF THE PREFERRED EMBODIMENTS

Embodiments of the present disclosure will be described in detail below with reference to the drawings. Note that the present invention is not limited to the embodiments. The details of one or a plurality of embodiments will be given in the following descriptions and the drawings. A plurality of embodiments can be appropriately combined with no inconsistency in processing details. In one or a plurality of embodiments below, the same parts are denoted with the same reference sings and thus duplicate description will be omitted.

### 1. Exemplary Embodiment

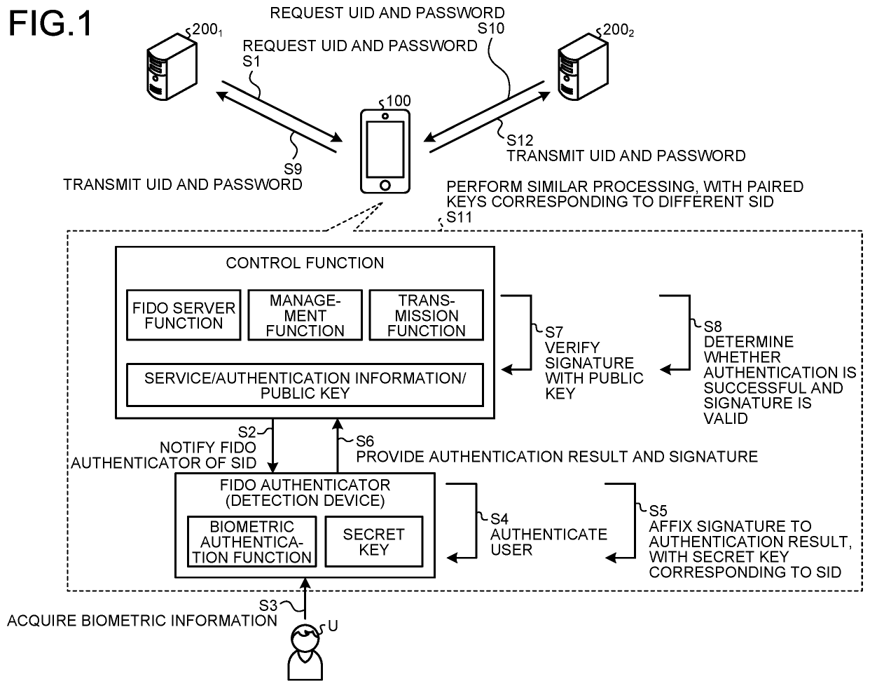

An exemplary embodiment of the present disclosure will be first described in detail with reference to FIG. 1.

1-1. Overview of Exemplary Embodiment

In order to solve problems related to the security and convenience of a password, FIDO authentication has been proposed. For example, such FIDO authentication has adopted local authentication with biometric information, such as a fingerprint, an iris, or a face, different from remote authentication that is an authentication technique with a password. However, replacement of conventional remote authentication with FIDO authentication causes a dramatic change in user experience in authentication. This results in a large barrier to introduction of FIDO authentication, in some cases. Therefore, a terminal device according to the exemplary embodiment performs FIDO authentication, locally. In a case where the FIDO authentication is successful, the terminal device transmits a user ID and a password to an authentication server having adopted remote authentication. Thus, the terminal device can achieve user experience similar to that in FIDO authentication, with no replacement of conventional remote authentication with FIDO authentication. As a result, the terminal device can reduce a barrier to introduction of FIDO authentication.

1-2. Introduction to Exemplary Embodiment

Various types of services on the Internet have typically adopted remote authentication with a password and an identifier (ID). In remote authentication, a password and an ID are transmitted from a client device to an authentication server through a network, such as the Internet. For example, when a user logs in to a service, the user inputs a password and an ID. Next, the authentication server verifies whether the received password is identical to the proper password associated with the ID stored in the authentication server.

One of problems related to remote authentication is that a user uses one password between a plurality of services. In general, a user has a plurality of accounts on a plurality of services, such as an electronic mail, a social networking service (SNS), an online video platform, online shopping, and online banking. In a case where a user sets a different password for each service, in some cases, it is difficult for the user to memorize the plurality of passwords different between the services. Thus, in some cases, a user makes passwords on a plurality of services the same. However, in a case where the password is leaked from one of the plurality of services, a malicious person is likely to carry out, with the password, unauthorized access to another service of the plurality of services.

In order to solve such a problem related to remote authentication as described above, the authentication technology called FIDO has been proposed. In an authentication mode of FIDO, the identity of a user is verified by an authenticator built in or attached externally to a user device, such as a smartphone. An example of the authenticator is a biometric authentication function in a smartphone. As above, FIDO authentication has adopted local authentication.

In local authentication, the authenticator affixes an electronic signature to a verification result of identity by using a secret key stored in the authenticator. Then, the verification result with the electronic signature is transmitted from the user device to a service on the Internet. The service on the Internet can confirm the validity of the verification result with the electronic signature transmitted from the user device, by using a public key registered in the service.

As described above, FIDO authentication enables passwordless authentication with an authenticator built in or attached externally to a user device. For example, a user inputs biometric information, such as a fingerprint, to a smartphone, so that a passwordless login can be performed in a service having adopted FIDO authentication. FIDO authentication enables a user to log in to a service with no password. Thus, FIDO authentication is desirable from the viewpoint of convenience and security.

However, in a case where remote authentication with a password and an ID is practically performed in a service on the Internet, in some cases, the remote authentication is difficult to change to local authentication. For example, in a case where a service in which remote authentication is practically performed introduces local authentication, such as FIDO authentication, the service needs to delete any existing password. In addition, the service needs to link a public key and an ID together to manage the public key and the ID. Deletion of passwords causes a dramatic change in user experience. Considering users familiar with passwords, in some cases, a service provider has difficulty in deleting passwords easily. For example, in a case where passwords disappear from a service, users familiar with passwords may hesitate to accept local authentication. As above, a change in user experience possibly results in a large barrier to introduction of local authentication, such as FIDO authentication.

Therefore, the terminal device according to the exemplary embodiment performs authentication processing to be described below, in order to provide user experience of a passwordless login with a password kept left. In the exemplary embodiment, the terminal device performs verification of the identity of a user, locally, with local authentication, such as FIDO authentication. At the time of local authentication, the user inputs biometric information, such as fingerprint information, instead of inputting a password. In a case where the identity of the user (namely, identity) is confirmed, the terminal device transmits a password and an ID stored in the terminal device to a service in which remote authentication is performed. The authentication processing according to the exemplary embodiment will be given below with reference to FIG. 1.

1-3. Authentication Processing

The authentication processing according to the exemplary embodiment will be described below with reference to FIG. 1.

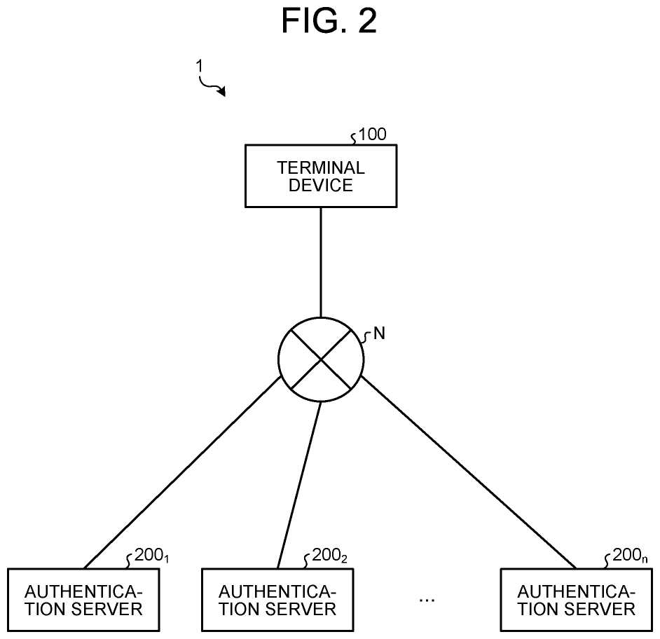

FIG. 1 is an explanatory diagram of exemplary authentication processing in which remote authentication is performed with local authentication, according to the exemplary embodiment of the present disclosure. In the exemplary embodiment, the authentication processing is performed by a terminal device 100 illustrated in FIG. 1. The terminal device 100 illustrated in FIG. 1, an authentication server 200₁, and an authentication server 200₂ are connected through a network, not illustrated in FIG. 1, such as the Internet (e.g., a network N to be described later with reference to FIG. 2).

In the example of FIG. 1, the terminal device 100 is indicated as a smartphone. In this example, the terminal device 100 has a control function of controlling whether a password of a user is transmitted. The terminal device 100 includes a detection device that detects information for use in verification of the identity of the user.

The control function includes a management function of managing authentication information for a service and a transmission function of transmitting the authentication information. In addition, the control function includes a FIDO server function that is the function of a server that performs FIDO authentication. Examples of the service include various types of services on the Internet, and examples of the authentication information include a user ID and a password. The FIDO server function has a public key associated with the service.

The management function and the transmission function can be implemented as a password manager installed on the terminal device 100. As described above, the control function includes the FIDO server function in addition to the management function and the transmission function. The control function can be implemented such that the FIDO server function is incorporated in the password manager. That is, the control function can be implemented as a FIDO enabled password manager. The terms “control function” and “password manager” can be used synonymously in the example of FIG. 1.

For simplification, in the example of FIG. 1, it is assumed that the user has previously registered a user ID and a password in the password manager. In this example, the user ID and the password are associated with the service ID of the service registered in the password manager (e.g., content on a website).

The detection device can be implemented as a FIDO authenticator. The detection device has an authentication function and a secret key associated with the service. In the example of FIG. 1, the detection device has a biometric authentication function. The biometric authentication function is an example of the authentication function. Note that other examples of the authentication function may include memory-based authentication and hardware-based authentication. The biometric authentication function is, for example, a fingerprint authentication function in a smartphone. The secret key corresponds to the public key in the control function described above. Note that, in the example of FIG. 1, the detection device is indicated as a FIDO authenticator built in the terminal device 100, but is not limited to this. The detection device may be a FIDO authenticator attached externally to the terminal device 100. The detection device may be a built-in authenticator, such as a fingerprint sensor, with which the terminal device 100 is equipped, or may be an external authenticator, such as a universal serial bus (USB) key.

In the example of FIG. 1, the authentication server 200₁ and the authentication server 200₂ are each indicated as a server. In this example, the authentication server 200₁ and the authentication server 200₂ are each provided by a relying party (RP). For example, the RPs are various types of services on the Internet, such as online shopping. In response to a request for access to the service from the terminal device 100, the authentication server 200₁ and the authentication server 200₂ each request the authentication information in order to authenticate the user on the service. The authentication server 200₁ and the authentication server 200₂ each request the authentication information for access to the service (e.g., content on a website), such as the user ID and the password.

As illustrated in FIG. 1, first, the authentication server 200₁ requests the user ID (UID) and the password (Step S1). The control function of the terminal device 100 detects the password request. Then, on the basis of the password request, the control function specifies the service ID (SID).

Next, the control function of the terminal device 100 notifies the detection device of the terminal device 100 (e.g., the FIDO authenticator) of the service ID (SID) (Step S2). For example, the control function notifies the detection device of a challenge together with the service ID. The challenge is a random character string that is one-time valid. The generated challenge may be associated with the particular service ID. The control function may store the challenge associated with the particular service ID, into a database. The control function transmits the service ID to the detection device to request the detection device to authenticate the user. The control function does not necessarily transmit the service ID to the detection device, but may transmit the challenge associated with the particular service ID to the detection device.

Next, the detection device acquires biometric information (Step S3). For example, the detection device acquires fingerprint information through the fingerprint sensor built in the terminal device 100 (e.g., a smartphone). The fingerprint sensor may be integrally formed with the touch panel of the terminal device 100.

Next, on the basis of the biometric information, the detection device authenticates the user (user) (Step S4). For example, the user touches the touch panel to input the fingerprint information to the terminal device 100. Then, on the basis of the fingerprint information, the FIDO authenticator authenticates the user and generates an authentication result.

Next, the detection device affixes a signature to the authentication result, with the secret key corresponding to the service ID (SID) (Step S5). The challenge may be included in the authentication result. For example, the detection device may affix a signature to the authentication result including the challenge. Affixing a signature to the authentication result includes affixing a signature to combined data generated by coupling the challenge to the authentication result. The detection device may affix a signature to the challenge. The secret key is stored in a secure region in the detection device. The detection device generates a hash value from the authentication result, so that a signature can be generated with the generated hash value and the secret key. In this case, the signature is data proving the identity of the user who utilizes the service associated with the service ID (e.g., a value generated with a cryptographic algorithm, such as elliptic curve cryptography).

Next, the detection device provides the authentication result and the signature to the control function (Step S6). The detection device can provide a certificate for the authentication result with the signature as an authentication assertion to the control function. The authentication assertion may include the service ID. The detection device may transmit the challenge with the signature as an assertion to the control function.

Next, the control function of the terminal device 100 verifies the signature, with the public key (Step S7). As described above, the control function has the public key associated with the service ID. For example, the control function can confirm whether a predetermined relational expression holds true (e.g., a relational expression for use in a cryptographic algorithm, such as elliptic curve cryptography), by using the public key. Thus, the control function can verify whether the signature is valid.

Next, the control function of the terminal device 100 determines whether the authentication is successful and the signature is valid (Step S8). In the example of FIG. 1, on the basis of the provided authentication assertion, the control function confirms the validity of a verification result. In this example, the control function determines that the authentication is successful and the signature is valid. In a case where the control function verifies the value of the challenge with the signature, resulting in confirmation of the identity of the user, the control function may acquire, from the database, the particular service ID associated with the challenge. Then, the control function may acquire the user ID and the password associated with the particular service ID.

Next, the control function of the terminal device 100 transmits the user ID (UID) and the password (Step S9). Then, the authentication server 200₁ performs remote authentication by using the transmitted user ID and password.

Next, similarly to the case of the authentication server 200₁, the authentication server 200₂ requests the user ID (UID) and the password (Step S10).

Next, the terminal device 100 performs similar processing, with the paired keys corresponding to the different service ID (SID) (Step S11). The control function of the terminal device 100 has a plurality of pairs of secret keys and public keys corresponding one-to-one to a plurality of services. The detection device of the terminal device 100 is capable of generating a plurality of pairs of secret keys and public keys. One of the plurality of secret keys generated is associated with the service ID of one of a plurality of services. Similarly, one of the plurality of public keys generated is associated with the service ID of one of the plurality of services. The generated secret keys are stored in the secure region in the detection device. Meanwhile, the generated public keys are provided to the control function.

After that, similarly to the case of the authentication server 200₁, the terminal device 100 transmits the user ID (UID) and the password (Step S12). In this case, the transmitted user ID and password are the authentication information for use in the service related to the authentication server 200₂. Then, the authentication server 200₂ performs remote authentication by using the transmitted user ID and password.

1-4. Effect in Exemplary Embodiment

As described above, the terminal device 100 according to the exemplary embodiment performs verification of the identity of the user, locally, by using the detection device built in or attached externally to the terminal device 100. Then, the terminal device 100 transmits the authentication information on the user to the authentication server 200₁ or the authentication server 200₂ to cause the authentication server 200₁ or the authentication server 200₂ to perform remote authentication.

Thus, the terminal device 100 can achieve user experience similar to that in FIDO authentication without altering existing password authentication systems. That is, even in a case where password authentication systems are each not altered to a FIDO authentication system, the user can log in to various types of services on the Internet without inputting passwords. The control function of the terminal device 100 can be implemented as a FIDO enabled password manager. The FIDO enabled password manager can provide experience of a login to a service with no password to users familiar with passwords. As a result, the FIDO enabled password manager can reduce a barrier to introduction of FIDO authentication. Furthermore, the FIDO enabled password manager can provide an authentication function having high security with FIDO authentication.

A terminal device 100 that performs such authentication processing will be described in detail below.

### 2. Configuration of Authentication System

Next, the configuration of a system including a terminal device 100 will be described with reference to FIG. 2.

FIG. 2 illustrates an exemplary configuration of an authentication system 1 according to an embodiment. As illustrated in FIG. 2, the authentication system 1 includes constituent elements, such as a terminal device 100 and authentication servers 200₁ to 200ₙ. In the present specification, in a case where no distinction is required between the authentication servers 200₁ to 200ₙ, the authentication servers 200₁ to 200ₙ are collectively referred to as “authentication server 200”. The authentication system 1 may include a plurality of terminal devices 100, not illustrated in FIG. 2. The authentication system 1 may include other constituent elements, such as devices of entities (e.g., a business operator and an end user) related to the terminal device 100.

In the authentication system 1, the terminal device 100 and the authentication servers 200 are each connected to a network N by wired communication or by wireless communication. The network N is a network, such as the Internet, a wide area network (WAN), or a local area network (LAN). The constituent elements of the authentication system 1 are capable of communicating with each other through the network N.

The terminal device 100 is an information processing device that a user uses. The terminal device 100 is capable of performing processing for user authentication. The terminal device 100 may be any of various types of information processing devices including client devices, such as a smartphone, a desktop personal computer (PC), a laptop PC, and a tablet PC.

The authentication servers 200 are each an information processing device that performs user authentication when the user accesses a service (e.g., content on a website). The authentication servers 200 may be each any of various types of information processing devices including a server. A plurality of authentication servers 200 may provide, respectively, the functions of various types of servers, such as a web server, an application server, and a database server.

### 3. Configuration of Terminal Device

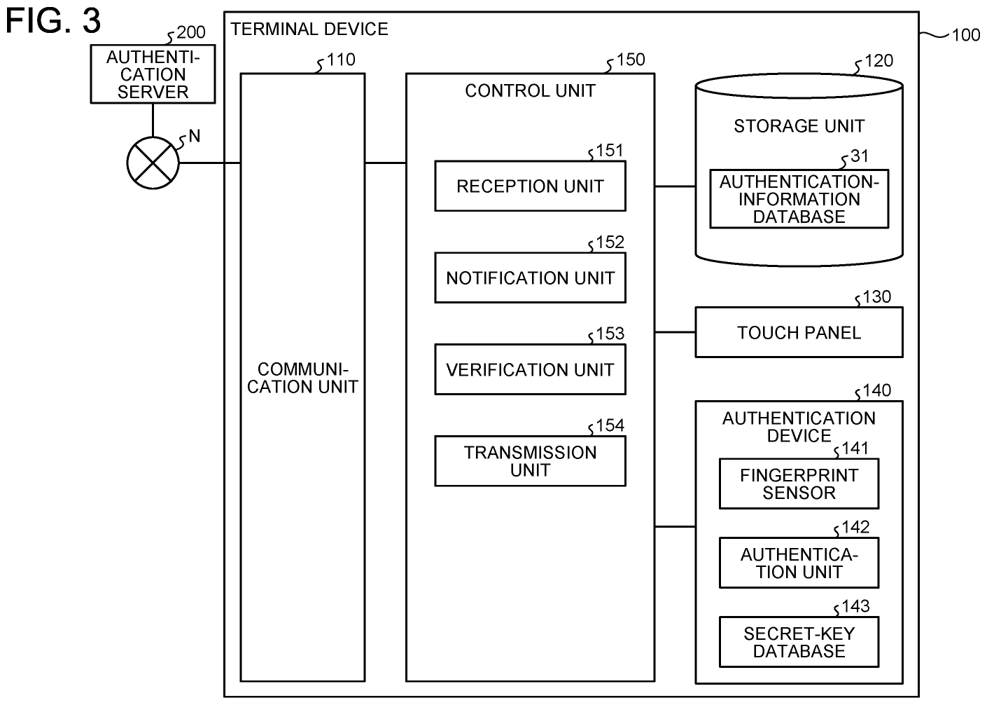

Next, an exemplary configuration of the terminal device 100 according to the embodiment will be described with reference to FIG. 3.

FIG. 3 illustrates the exemplary configuration of the terminal device 100 according to the embodiment. As illustrated in FIG. 3, the terminal device 100 includes a communication unit 110, a storage unit 120, a touch panel 130, an authentication device 140, and a control unit 150. Note that the terminal device 100 may include: an input unit (e.g., a keyboard or a mouse) that receives various types of operations from, for example, an administrator who utilizes the terminal device 100; and a display unit (e.g., a liquid crystal display) that displays various types of information.

Communication Unit 110

The communication unit 110 is achieved, for example, by a network interface card (NIC). The communication unit 110 is connected to a network by wired communication or by wireless communication. The communication unit 110 may be connected communicably to an authentication server 200 through the network N. The communication unit 110 can transmit information to and receive information from the authentication server 200 through networks.

Storage Unit 120

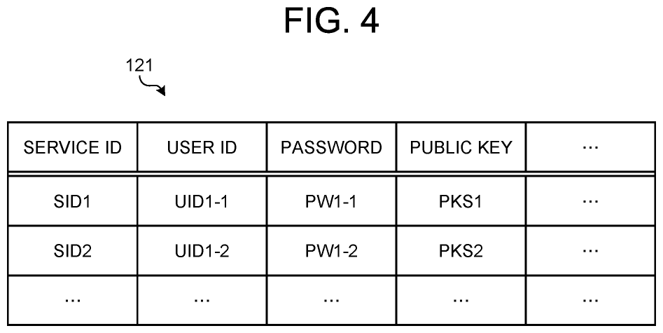

The storage unit 120 is achieved, for example, by a semiconductor memory element, such as a random access memory (RAM) or a flash memory, or by a storage device, such as a hard disk or an optical disc. As illustrated in FIG. 4, the storage unit 120 includes an authentication-information database 121.

Authentication-Information Database 121

FIG. 4 illustrates an example of the authentication-information database 121 according to the embodiment. The authentication-information database 121 stores authentication information.

In at least one embodiment, the authentication-information database 121 stores the authentication information for each service.

In the example of FIG. 4, the authentication-information database 121 includes items, such as “service ID”, “user ID”, “password”, and “public key”. The exemplified items of the authentication-information database 121 may be the attributes of an entity in the database. The “service ID” may be a primary key. The “user ID” may be a foreign key.

The “service ID” indicates an identifier for identification between various types of services on the Internet. The “user ID” indicates an ID for use in a service associated with a service ID. The “password” indicates a password for use in the service associated with the service ID. Note that the authentication-information database 121 may store a hashed password. For example, the password “PW1-1” indicated in FIG. 4 is not necessarily the original password and thus may be a hashed password. A password to be stored may be generated by hashing of a character string including the original password and a salt. The “public key” indicates a public key for use in verification of the identity of the user who utilizes the service associated with the service ID.

For example, FIG. 4 indicates that the ID and the password for use in the service identified with the service ID “SID1” are “UDI-1” and “PW1-1”, respectively. For example, FIG. 4 indicates that the public key for use in verification of the identity of the user who utilizes the service identified with the service ID “SID1” is “PKS1”.

Touch Panel 130

The touch panel 130 is capable of receiving a touch operation. The authentication device 140 may be integrally formed with the touch panel 130. In response to reception of a touch operation, the touch panel 130 may transmit fingerprint information to the authentication device 140. A fingerprint sensor may be built in the touch panel 130. For example, a fingerprint icon may be displayed on the touch panel 130.

Authentication Device 140

The authentication device 140 is a detection device that performs verification of the identity of the user, locally. The authentication device 140 can be implemented as a detection device that detects information for use in verification of the identity of the user. For example, the authentication device 140 is a FIDO authenticator. As described above with reference to FIG. 1, the detection device includes, for example, a biometric authentication function and a secret key associated with a service. As illustrated in FIG. 3, the authentication device 140 includes a fingerprint sensor 141, an authentication unit 142, and a secret-key database 143.

Fingerprint Sensor 141

The fingerprint sensor 141 is capable of reading user's fingerprints. The fingerprint sensor 141 is an exemplary detection unit that detects information on the user (user). For example, the fingerprint sensor 141 is capable of generating a fingerprint image, on the basis of the unevenness of a fingerprint. The fingerprint sensor 141 may be integrally formed with the touch panel 130.

Authentication Unit 142

In at least one embodiment, in response to reception of a transmission request for authentication information for use in authentication of the user from an authentication device that performs the authentication of the user in a predetermined service, the authentication unit 142 performs the authentication of the user, on the basis of information on the user detected by a predetermined detection device.

In at least one embodiment, the authentication unit 142 performs the authentication of the user, with information detected by a detection unit (e.g., the fingerprint sensor 141). The detection unit may be a camera capable of iris authentication or face authentication.

In at least one embodiment, the authentication unit 142 generates a signature to an authentication result, with a previously created secret key. For example, the authentication unit 142 generates the signature to the authentication result, with the secret key varying between services as a requestor for the authentication information. For example, in response to reception of a transmission request for the authentication information from another authentication device, the authentication unit 142 generates the secret key and a public key corresponding to the secret key and provides the generated public key to a transmission unit 154, to be described later.

In at least one embodiment, the authentication unit 142 performs the authentication of the user, with biometric information detected by the detection device. In this case, for example, the detection unit described above (e.g., the fingerprint sensor 141 or the camera capable of iris authentication or face authentication) is an example of the detection device.

As an example, first, the authentication unit 142 acquires biometric information. For example, the authentication unit 142 acquires fingerprint information through the fingerprint sensor 141 built in the terminal device 100 (e.g., a smartphone).

Next, on the basis of the acquired biometric information, the authentication unit 142 authenticates the user (user). For example, the user touches the touch panel to input fingerprint information to the touch panel 130 or the fingerprint sensor 141. Then, on the basis of the input fingerprint information, the authentication unit 142 authenticates the user and generates an authentication result.

Next, the authentication unit 142 affixes a signature to the authentication result, with the secret key corresponding to the service ID (SID). A challenge may be included in the authentication result. For example, the authentication unit 142 may affix a signature to the authentication result including the challenge. The authentication unit 142 may affix a signature to the challenge. The secret key is stored in a secure region in the detection device (e.g., the secret-key database 143, to be described later). The authentication unit 142 generates a hash value from the authentication result, so that a signature can be generated with the generated hash value and the secret key. In this case, the signature is data proving the identity of the user who utilizes the service associated with the service ID (e.g., a value generated with a cryptographic algorithm, such as elliptic curve cryptography).

After that, the authentication unit 142 provides the authentication result and the signature to the control unit 150, to be described later. The authentication unit 142 can provide a certificate for the authentication result with the signature as an authentication assertion to the control unit 150. The authentication assertion may include the service ID. The authentication unit 142 may transmit the challenge with the signature as an assertion to the control function.

As an example, the authentication unit 142 is capable of generating a plurality of pairs of secret keys and public keys. One of the plurality of secret keys generated is associated with the service ID of one of a plurality of services. Similarly, one of the plurality of public keys generated is associated with the service ID of one of the plurality of services. The authentication unit 142 stores the generated secret keys into the secure region in the detection device (e.g., the secret-key database 143, to be described later). In addition, the authentication unit 142 provides the generated public keys to the control unit 150 (e.g., a reception unit 151, a verification unit 153, and a transmission unit 154), to be described later. For example, the authentication unit 142 may affix a signature to the authentication result including the challenge. Then, the authentication unit 142 may transmit the challenge with the signature, to the control unit 150. The authentication unit 142 can acquire a secret key from the secure region in the detection device (e.g., the secret-key database 143, to be described later).

Secret-Key Database 143

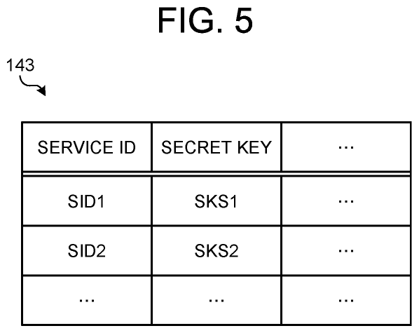

FIG. 5 illustrates an example of the secret-key database 143 according to the embodiment. The secret-key database 143 stores a secret key. In some implementations, a public key is present in a client device instead of being present in an authentication server. The public key is capable of decrypting the signature encrypted with the secret key.

In the example of FIG. 5, the secret-key database 143 includes items, such as “service ID” and “secret key”. The exemplified items of the secret-key database 143 may be the attributes of an entity in the database. The “service ID” may be a primary key.

The “service ID” indicates an identifier for identification between various types of services on the Internet. The “secret key” indicates a secret key for use in verification of the identity of the user who utilizes a service associated with a service ID.

For example, FIG. 5 indicates that the secret key for use in verification of the identity of the user who utilizes the service identified with the service ID “SID1” is “SKS1”.

Control Unit 150

The control unit 150 is a controller and is achieved, for example, by execution of various types of programs (corresponding to exemplary information processing programs) stored in the storage device inside the terminal device 100, on the RAM as a work area, by a processor, such as a central processing unit (CPU) or a micro processing unit (MPU). The control unit 150 may be a controller and may be achieved, for example, by an integrated circuit, such as an application specific integrated circuit (ASIC), a field programmable gate array (FPGA), or a general purpose graphic processing unit (GPGPU).

As illustrated in FIG. 3, the control unit 150 includes a reception unit 151, a notification unit 152, a verification unit 153, and a transmission unit 154, and achieves or performs the function and effect of information processing to be described below. The control unit 150 can achieve the authentication processing described above with reference to FIG. 1. One or a plurality of processors of the terminal device 100 executes commands stored in one or a plurality of memories of the terminal device 100, so that the function of each control unit in the control unit 150 can be achieved. Note that the internal configuration of the control unit 150 is not limited to the configuration illustrated in FIG. 3 and thus provided may be any configuration enabling the information processing to be described later. For example, the transmission unit 154 may perform the entirety or part of the information processing, to be described later, regarding the units other than the transmission unit 154.

Reception Unit 151

The reception unit 151 is capable of receiving various types of information for use in performance of processing for user authentication.

The reception unit 151 is capable of receiving, through a user interface, authentication information, such as a user ID and a password, from the user who utilizes the terminal device 100. For example, when the terminal device 100 accesses a service (e.g., content on a website), the reception unit 151 may display, through a browser, the message “Would you like to register this website?” to the user. Such a function of the reception unit 151 can be implemented as an extension function for the browser. As above, the reception unit 151 is capable of receiving the authentication information through the browser.

In response to reception of the authentication information, such as the user ID and the password, the reception unit 151 can generate the service ID of the service. Then, the reception unit 151 can request the authentication device 140 to generate a pair of the public key and the secret key corresponding to the service. For generation of a pair of the public key and the secret key corresponding to the service, the reception unit 151 may transmit a challenge to the authentication device 140. The reception unit 151 can receive the public key corresponding to the service from the authentication device 140. The reception unit 151 can store the received user ID, password, and public key into the authentication-information database 121. As described above with reference to FIG. 4, the stored user ID and password are associated with the public key corresponding to the particular service.

The reception unit 151 transmits an access request to the authentication server 200, so that a request for the authentication information, such as the user ID and the password, can be received from the authentication server 200.

As an example, the reception unit 151 detects a password request. Then, on the basis of the password request, the reception unit 151 specifies the service ID from the authentication-information database 121. The reception unit 151 can acquire the service ID from the authentication-information database 121.

Notification Unit 152

The notification unit 152 is capable of notifying the authentication device 140 of the service ID specified by the reception unit 151.

As an example, the notification unit 152 notifies the detection device (e.g., the FIDO authenticator) of the service ID. For example, the notification unit 152 notifies the authentication device 140 of a challenge together with the service ID. The generated challenge may be associated with the particular service ID. The notification unit 152 may store the challenge associated with the particular service ID, into the database in the storage unit 120. The notification unit 152 transmits the service ID to the detection device to request the detection device to authenticate the user. The notification unit 152 does not necessarily transmit the service ID to the authentication device 140, but may transmit the challenge associated with the particular service ID to the authentication device 140.

Verification Unit 153

For example, the verification unit 153 is capable of verifying the signature provided from the authentication device 140 (e.g., the authentication unit 142).

As an example, the verification unit 153 the verification unit 153 verifies the signature, with the public key. The verification unit 153 can acquire the public key associated with the service ID from the authentication-information database 121. For example, the verification unit 153 can confirm whether a predetermined relation expression holds true (e.g., a relational expression for use in a cryptographic algorithm, such as elliptic curve cryptography), by using the public key. Thus, the verification unit 153 can verify whether the signature is valid.

Transmission Unit 154

In at least one embodiment, the transmission unit 154 transmits the authentication information on the user to the authentication device in a case where authentication is performed by the authentication unit 142.

In at least one embodiment, the transmission unit 154 transmits the authentication information corresponding to the service as the transmission source of the transmission request.

In at least one embodiment, the transmission unit 154 verifies the signature generated by the authentication unit 142, with the public key corresponding to the secret key, and then transmits the authentication information in response to acquisition of the authentication result indicating that the signature is valid and the user has been authenticated. For example, the transmission unit 154 verifies the signature, with the public key corresponding to the service as the requestor for the authentication information. In this respect, the transmission unit 154 may perform the entirety or part of the information processing, described above, regarding the verification unit 153.

In at least one embodiment, the transmission unit 154 transmits the authentication information through an application interface for performing the authentication of the user to the authentication device.

In at least one embodiment, the transmission unit 154 transmits, as the authentication information, identification information for identification of the user and the password corresponding to the identification information.

As an example, the transmission unit 154 determines whether the authentication is successful and the signature is valid. As described above with reference to FIG. 1, for example, on the basis of the provided authentication assertion, the transmission unit 154 confirms the validity of a verification result. Then, the transmission unit 154 transmits the user ID and the password to the authentication server 200. The transmission unit 154 can acquire the user ID and the password from the authentication-information database 121. In a case where the verification unit 153 verifies the value of the challenge with the signature, resulting in confirmation of the identity of the user, the transmission unit 154 may acquire the particular service ID associated with the challenge from the database. Then, the transmission unit 154 may acquire the user ID and the password associated with the particular service ID from the authentication-information database 121.

As described above, the control unit 150 can have a FIDO server function. That is, the client device (e.g., the terminal device 100) can have the FIDO server function. The password manager installed on the client device is capable of managing not only a password but also the FIDO server function. The password manager is capable of associating a password and a service together.

Furthermore, the password manager is capable of associating a public key and the service together. Although the control unit 150 can be regarded as the password manager, the control unit 150 can have the FIDO server function. The control unit 150 is capable of converting the public key into the password, with the service ID. As above, the FIDO server function installed on the client device can serve as an authentication server.

### 4. Flow of Authentication Processing

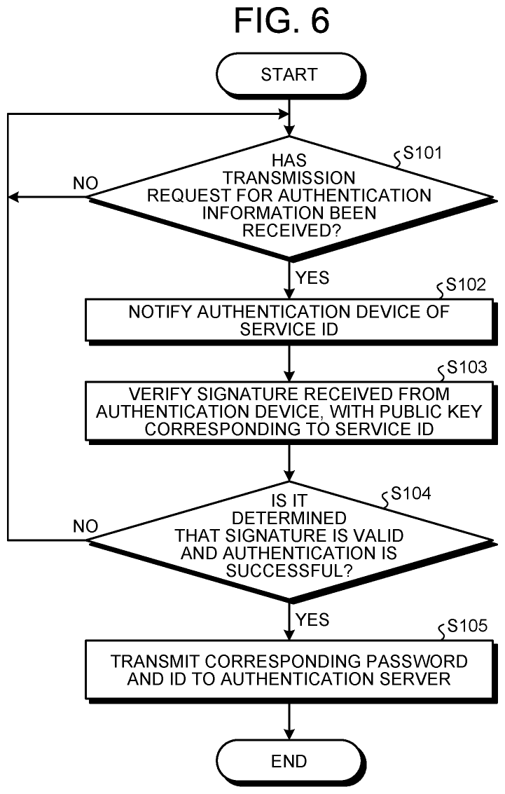

Next, a procedure of authentication processing by the terminal device 100 according to the embodiment will be described with reference to FIG. 6.

FIG. 6 is a flowchart of a processing procedure of remote authentication with local authentication, performed by the terminal device 100 according to the embodiment.

As illustrated in FIG. 6, first, the reception unit 151 of the terminal device 100 determines whether the reception unit 151 has received any transmission request for authentication information (Step S101). In a case where the reception unit 151 determines that the reception unit 151 has not received transmission request for authentication information (Step S101: No), the reception unit 151 performs Step S101 again.

In a case where the reception unit 151 determines that the reception unit 151 has received a transmission request for authentication information (Step S101: Yes), the notification unit 152 of the terminal device 100 notifies the authentication device 140 of the service ID (Step S102).

Next, the verification unit 153 of the terminal device 100 verifies the signature received from the authentication device 140, with the public key corresponding to the service ID (Step S103).

Next, the transmission unit 154 of the terminal device 100 determines whether the signature is valid and the authentication is successful (Step S104). In a case where the transmission unit 154 determines that the signature is invalid or the authentication is unsuccessful (Step S104: No), the reception unit 151 performs Step S101 again.

In a case where the transmission unit 154 determines that the signature is valid and the authentication is successful (Step S104: Yes), the transmission unit 154 transmits the corresponding password and ID to the authentication server 200 (Step S105).

### 5. Other Embodiments

The terminal device 100 according to the embodiment described above may be carried out in various different modes in addition to the embodiment described above. Thus, other embodiments of the above terminal device 100 will be described below.

5-1. Attestation

In some implementations, a secret key and a public key for attestation may be present in a client device. The terminal device 100 can have a secret key and a public key for attestation. As described above, the authentication unit 142 of the authentication device 140 is capable of generating a plurality of secret keys corresponding one-to-one to a plurality of services and a plurality of public keys corresponding one-to-one to the plurality of services. Meanwhile, a secret key and a public key for attestation may be stored in advance in the secret-key database 143 of the authentication device 140. For example, the vendor for the authentication device 140 may distribute a secret key and a public key for attestation at the time of shipment.

5-2. Aspects of Provision of Control Function

A terminal device, such as a smartphone, can download, as an application, the function of the control unit 150 described above. For example, the FIDO enabled password manager described above may be distributed as an application. A particular Internet enterprise may provide such a password manager through a distribution service for digital content.

### 6. Others

Among the pieces of processing described in the above embodiment, part of the processing described as automatically performable can be performed manually. Alternatively, the entirety or part of the processing described as manually performable can be automatically performed by a publicly known method. In addition, unless otherwise specified, the processing procedure, specific names, and information including the various types of data and parameters indicated in the above description and in the drawings can be changed appropriately. For example, the various types of information indicated in each figure are not limited to the illustrated information.

Each constituent element in each device illustrated is conceptual in function and thus is not necessarily provided physically as illustrated. That is, each device is not limited in specific mode of division/integration to the illustration and thus the entirety or part thereof can be functionally or physically subjected to division/integration in an appropriate unit, in accordance with various types of loads or usage conditions.

### 7. Hardware Configuration

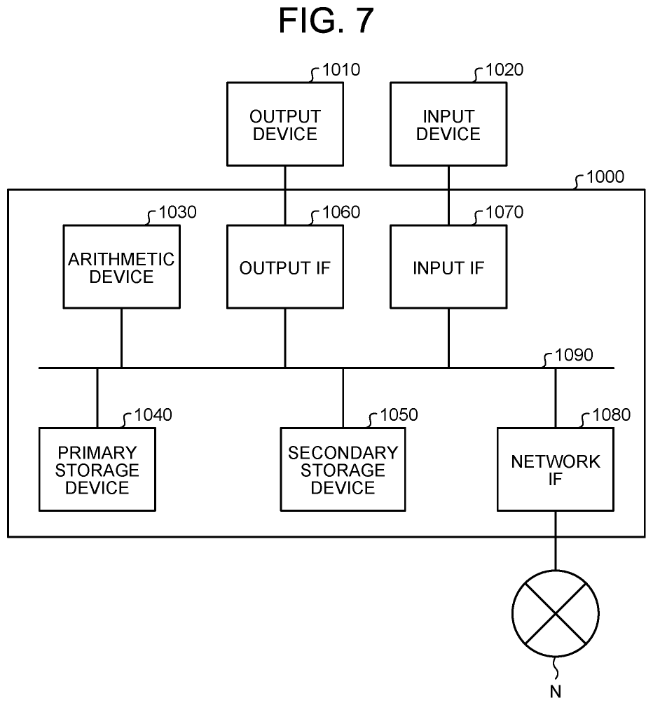

The terminal device 100 according to the embodiment described above is achieved, for example, by a computer 1000 having such a configuration as illustrated in FIG. 7. FIG. 7 illustrates an exemplary hardware configuration. The computer 1000 includes an arithmetic device 1030, a primary storage device 1040, a secondary storage device 1050, an output interface (IF) 1060, an input IF 1070, and a network IF 1080 that are connected to an output device 1010 and an input device 1020 through a bus 1090.

The arithmetic device 1030 operates to perform various types of processing, for example, on the basis of a program stored in the primary storage device 1040 or the secondary storage device 1050 or a program read from the input device 1020. The primary storage device 1040 is a memory device, such as a RAM, that temporarily stores data that the arithmetic device 1030 uses in various types of computations. The secondary storage device 1050 is a storage device for data that the arithmetic device 1030 uses in various types of computations or for registration of various types of databases, and is achieved, for example, by a read only memory (ROM), a hard disk drive (HDD), or a flash memory.

The output IF 1060 is an interface for transmitting information to be output to the output device 1010, such as a monitor or a printer, that outputs various types of information, and is achieved, for example, by a connector based on a standard, such as USB, Digital Visual Interface (DVI), or High Definition Multimedia Interface (HDMI) (registered trademark). The input IF 1070 is an interface for receiving information from various types of input devices 1020, such as a mouse, a keyboard, and a scanner, and is achieved, for example, by a USB.

Note that the input device 1020 may be a device that reads information from, for example, an optical recording medium, such as a compact disc (CD), a digital versatile disc (DVD), or a phase change rewritable disk (PD), a magneto-optical recording medium, such as a magneto-optical disk (MO), a tape medium, a magnetic recording medium, or a semiconductor memory. The input device 1020 may be an external storage medium, such as a USB memory.

The network IF 1080 receives data from a different apparatus through the network N and sends the data to the arithmetic device 1030 or transmits data generated by the arithmetic device 1030 to the different apparatus through the network N.

The arithmetic device 1030 controls the output device 1010 through the output IF 1060 or controls the input device 1020 through the input IF 1070. For example, the arithmetic device 1030 loads the program from the input device 1020 or the secondary storage device 1050, onto the primary storage device 1040 and executes the loaded program.

For example, in a case where the computer 1000 functions as the terminal device 100, the arithmetic device 1030 of the computer 1000 executes the program loaded on the primary storage device 1040 to achieve the function of the control unit 150.

### 8. Effect

As described above, the terminal device 100 according to the embodiment includes the authentication unit 142 and the transmission unit 154.

In the terminal device 100 according to the embodiment, in response to a transmission request for authentication information for use in authentication of the user from an authentication device that performs the authentication of the user in a predetermined service, the authentication unit 142 performs the authentication of the user, on the basis of information on the user detected by a predetermined detection device. In the terminal device 100 according to the embodiment, in a case where the authentication is performed by the authentication unit 142, the transmission unit 154 transmits the authentication information on the user to the authentication device.

The terminal device 100 according to the embodiment includes a detection unit (e.g., the fingerprint sensor 141) that detects information of the user. In the terminal device 100 according to the embodiment, the authentication unit 142 performs the authentication of the user, with the information detected by the detection unit.

The terminal device 100 according to the embodiment includes: an authentication device including the detection unit and the authentication unit 142; and an information processing device including the transmission unit 154.

The terminal device 100 according to the embodiment includes a storage unit (e.g., the authentication-information database 121) that stores the authentication information for each service. In the terminal device 100 according to the embodiment, the transmission unit 154 transmits the authentication information corresponding to the service as the transmission source of the transmission request.

In the terminal device 100 according to the embodiment, the authentication unit 142 generates a signature to an authentication result, with a secret key previously created. In the terminal device 100 according to the embodiment, the transmission unit 154 verifies the signature generated by the authentication unit 142, with a public key corresponding to the secret key, and transmits the authentication information in response to acquisition of the authentication result indicating that the signature is valid and the user has been authenticated.

In the terminal device 100 according to the embodiment, the authentication unit 142 generates the signature to the authentication result, with the secret key varying between services as a requestor for the authentication information. In the terminal device 100 according to the embodiment, the transmission unit 154 verifies the signature, with the public key corresponding to the service as the requestor for the authentication information.

In the terminal device 100 according to the embodiment, in response to reception of a transmission request for the authentication information from another authentication device, the authentication unit 142 generates the secret key and a public key corresponding to the secret key and provides the generated public key to the transmission unit 154.

In the terminal device 100 according to the embodiment, the authentication unit 142 performs the authentication of the user, with biometric information detected by the detection device.

In the terminal device 100 according to the embodiment, the transmission unit 154 transmits the authentication information through an application interface for performing the authentication of the user to the authentication device.

In the terminal device 100 according to the embodiment, the transmission unit 154 transmits, as the authentication information, identification information for identification of the user and a password corresponding to the identification information.

Each piece of processing described above enables the terminal device 100 to further facilitate authentication. In a password-based authentication system, the terminal device 100 enables no need for manual input of a password and memorization of a password. Thus, the terminal device 100 enables a user or a service to set, as a password, a long character string difficult to memorize. As a result, the terminal device 100 can enhance the security of the authentication system without altering the authentication system.

The embodiments of the present application have been described in detail above on the basis of the drawings, but are exemplary. Thus, the present invention can be carried out in other modes in which various modifications and improvements are made on the basis of the knowledge of person skilled in the art, in addition to in the aspects in the disclosure of the invention.

The term “section”, “module”, or “unit” described above can be replaced with, for example, the term “means” or “circuit”. For example, a reception unit can be replaced with a reception means or a reception circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device comprising:
an authentication unit configured to perform, in response to reception of a transmission request for authentication information for use in authentication of a user from an authentication device that performs the authentication of the user in a predetermined service, the authentication of the user, based on information on the user detected by a predetermined detection device; and
a transmission unit configured to transmit, in a case where the authentication is performed by the authentication unit, the authentication information on the user to the authentication device.

2. The terminal device according to claim 1, further comprising:
a detection unit configured to detect information on the user, wherein
the authentication unit performs the authentication of the user, with the information detected by the detection unit.

3. The terminal device according to claim 2, further comprising:
an authentication device including the detection unit and the authentication unit; and
an information processing device including the transmission unit.

4. The terminal device according to claim 1, further comprising:
a storage unit configured to store the authentication information for each service, wherein
the transmission unit transmits the authentication information corresponding to the service as a transmission source of the transmission request.

5. The terminal device according to claim 1, wherein
the authentication unit generates a signature to an authentication result, with a secret key previously created, and
the transmission unit verifies the signature generated by the authentication unit, with a public key corresponding to the secret key, and transmits, in response to acquisition of the authentication result indicating that the signature is valid and the user has been authenticated, the authentication information.

6. The terminal device according to claim 5, wherein
the authentication unit generates the signature to the authentication result, with a secret key varying between services as a requestor for authentication information, and
the transmission unit verifies the signature, with a public key corresponding to the service as the requestor for the authentication information.

7. The terminal device according to claim 5, wherein
the authentication unit generates, in response to reception of a transmission request for the authentication information from another authentication device, the secret key and the public key corresponding to the secret key and provides the generated public key to the transmission unit.

8. The terminal device according to claim 1, wherein
the authentication unit performs the authentication of the user, with biometric information detected by the detection device.

9. The terminal device according to claim 1, wherein
the transmission unit transmits the authentication information through an application interface for performing the authentication of the user to the authentication device.

10. The terminal device according to claim 1, wherein
the transmission unit transmits, as the authentication information, identification information for identification of the user and a password corresponding to the identification information.

11. An information processing method that a computer performs, the information processing method comprising:
an authentication step of performing, in response to reception of a transmission request for authentication information for use in authentication of a user from an authentication device that performs the authentication of the user in a predetermined service, the authentication of the user, based on information on the user detected by a predetermined detection device; and
a transmission step of transmitting, in a case where the authentication is performed by the authentication step, the authentication information on the user to the authentication device.

12. A non-transitory computer readable storage medium having an information processing grogram stored thereon, the information processing grogram causes a computer to perform:
an authentication procedure of performing, in response to reception of a transmission request for authentication information for use in authentication of a user from an authentication device that performs the authentication of the user in a predetermined service, the authentication of the user, based on information on the user detected by a predetermined detection device; and
a transmission procedure of transmitting, in a case where the authentication is performed by the authentication procedure, the authentication information on the user to the authentication device.
